(19) United States
(12) Patent Application Publication
(10) Pub. No.: US 2024/0066664 A1
(43) Pub. Date: Feb. 29, 2024

(54) PAD SURFACE CLEANING DEVICE AROUND PAD CONDITIONER TO ENABLE INSITU PAD CONDITIONING

(71) Applicant: Applied Materials, Inc., Santa Clara, CA (US)

(72) Inventors: Shou-Sung CHANG, Mountain View, CA (US); Hui CHEN, Tempe, AZ (US); Haosheng WU, Fremont, CA (US); Jianshe TANG, San Jose, CA (US); Sidney P. HUEY, Fremont, CA (US); Jeonghoon OH, Saratoga, CA (US); Chad POLLARD, San Jose, CA (US); Chih Chung CHOU, San Jose, CA (US); Sameer A. DESHPANDE, Milpitas, CA (US)

(21) Appl. No.: 18/363,545

(22) Filed: Aug. 1, 2023

Related U.S. Application Data
(60) Provisional application No. 63/400,463, filed on Aug. 24, 2022.

(51) Int. Cl. B24B 53/017; B08B 3/02; B08B 5/04; B24B 57/02

(52) U.S. Cl. CPC B24B 53/017; B08B 3/02; B08B 5/04; B24B 57/02

(57) ABSTRACT

The present disclosure relates to a pad surface cleaning system to be used with a conditioning module to condition a polishing surface of a polishing pad. The pad surface cleaning system may be used to spray the polishing surface with a high-pressure fluid spray to loosen debris from the polishing surface. The pad surface cleaning system may also be used to remove the loosened debris. Further, the pad surface cleaning system may isolate a conditioning disk from a polishing fluid to protect the conditioning disk from reacting with the polishing fluid.

### CROSS-REFERENCE TO RELATED APPLICATIONS

This application claims priority to U.S. Provisional Patent Application No. 63/400,463, filed Aug. 24, 2022, which is herein incorporated by reference in its entirety.

### BACKGROUND

### Field

Embodiments of the present disclosure generally relate to apparatuses and methods of conditioning a polishing pad. More particularly, embodiments of the present disclosure relate to a pad surface cleaning system to remove debris from the polishing pad and insulate a polishing disk from a polishing fluid.

### Description of the Related Art

Processing stations for performing a polishing process, such as a chemical mechanical planarization (CMP) or electrochemical mechanical planarization (ECMP) process, use a polishing pad and a polishing fluid to polish a substrate. A polishing surface of the polishing pad contacts the substrate and removes pieces of the substrate to planarize the substrate and smoothen a surface of the substrate. The polishing fluid may be disposed in between the polishing surface and the substrate to facilitate removal of material. The polishing pad may have a rough surface to contact the substrate. Over time, the rough surface may smoothen out and the polishing pad may no longer planarize of the substrate. Pieces of the substrate or abrasive particles from the polishing fluid may also become embedded or smeared into the polishing pad and result in less effective planarization or contamination of subsequent substrates polished by the polishing pad.

A conditioning disk is used with the polishing fluid to condition the polishing surface and remove the embedded material. Conventional methods of conditioning the polishing pad involve conditioning the polishing pad in between polishing steps in an isolated step, where no other polishing actions can occur. The isolated step may increase a time required to polish the substrate and reduce an availability of the processing station. The polishing fluid may degrade or corrode the conditioning disk or the conditioning disk may also further smear the embedded material or embed pieces of the conditioning disk that may become dislodged during conditioning.

Accordingly, what is needed in the art are apparatus and methods for solving the problems described above.

### SUMMARY

The present disclosure generally relates to apparatuses and methods of conditioning a polishing pad. More particularly, embodiments of the present disclosure relate to a pad surface cleaning system to remove debris from the polishing pad and insulate a polishing disk from a polishing fluid.

Certain embodiments provide a polishing pad cleaning system for a substrate polishing process. The polishing pad cleaning system comprises an outer wash ring comprising outer nozzles, wherein the outer nozzles are configured to be coupled to a first fluid source, an inner wash ring comprising inner nozzles, wherein the inner nozzles are configured to be coupled to a second fluid source and a vacuum ring, wherein the vacuum ring forms a vacuum port configured to be fluidly coupled to a vacuum source. A conditioning disk is configured to be disposed within the polishing pad cleaning system and to condition a polishing pad. The outer nozzles are configured to loosen debris from the substrate polishing process. The inner nozzles are configured to loosen debris from conditioning the polishing pad, and the vacuum ring is configured to remove the debris loosened by the outer wash ring and inner wash ring.

Other embodiments provide a conditioning system for conditioning a polishing pad. The conditioning system comprises a conditioning module comprising a conditioning arm and a conditioning head, wherein the conditioning head is configured to urge a conditioning disk against the polishing pad, and a polishing pad cleaning system coupled to the conditioning arm. The polishing pad cleaning system comprises an outer wash ring comprising outer nozzles configured to couple to a first fluid source, a vacuum ring comprising a vacuum port configured to couple to a vacuum source, and an inner wash ring comprising inner nozzles configured to couple to a second fluid source.

Other embodiments provide a method for conditioning a polishing pad. The method comprises positioning a conditioning disk with respect to a polishing pad within a polishing pad cleaning system. The polishing pad cleaning system comprises an outer wash ring comprising outer nozzles, wherein the outer nozzles are coupled to a first fluid source, an inner wash ring comprising inner nozzles, wherein the inner nozzles are coupled to a second fluid source, and a vacuum ring, wherein the vacuum ring forms a vacuum port fluidly coupled to a vacuum source. The method further comprises flowing a fluid from the first fluid source through the outer nozzles to loosen debris from the polishing pad during a substrate polishing process, removing the debris from the polishing pad during the substrate polishing process through the vacuum port by creating an underpressure using the vacuum source, flowing a fluid from the second fluid source through the inner nozzles to loosen debris from the polishing pad during the substrate polishing process, and removing the debris from the polishing pad during the substrate polishing process through the vacuum port by creating an underpressure using the vacuum source.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of the scope of the disclosure, as the disclosure may admit to other equally effective embodiments.

FIG. 1 depicts a top plan view of a processing station, according to some embodiments.

FIG. 2 depicts a schematic side view of a processing station, according to some embodiments.

FIG. 3 depicts a top plan view of a pad surface cleaning system, according to some embodiments.

FIG. 4A depicts a schematic side view of the pad surface cleaning system from FIG. 3, according to some embodiments.

FIGS. 4B and 4C depict a schematic side view of the pad surface cleaning system from FIG. 4A, according to some embodiments.

FIG. 5 depicts a schematic side view of a rotatable pad surface cleaning system, according to some embodiments.

FIGS. 6A-6C depict top plan views of different pad surface cleaning systems, according to some embodiments.

FIG. 7 depicts a top schematic view of a pad surface cleaning system moving in relation to a polishing fluid delivery point, according to some embodiments.

FIG. 8 depicts a top schematic view of a pad surface cleaning system and a polishing fluid delivery point moving in relation to a polishing pad, according to some embodiments.

FIG. 9 depicts a functional block diagram of a system controller for a pad surface cleaning system, according to some embodiments.

FIG. 10 depicts a flowchart of a method for conditioning a polishing pad, according to some embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following description, numerous specific details are set forth to provide a more thorough understanding of the present disclosure. However, it will be apparent to one of skill in the art that some embodiments of the present disclosure may be practiced without one or more of these specific details. In other instances, well-known features have not been described in order to avoid obscuring one or more embodiments of the present disclosure.

The present disclosure relates to a pad surface cleaning system to be used with a conditioning module to condition a polishing surface of a polishing pad. The pad surface cleaning system may be used to spray the polishing surface with a high-pressure fluid spray to loosen debris from the polishing surface. The pad surface cleaning system may also be used to remove the loosened debris. Further, the pad surface cleaning system may isolate a conditioning disk from a polishing fluid to protect the conditioning disk from reacting with the polishing fluid.

The methods and systems disclosed herein may provide features that overcome many of the disadvantages associated with conventional processing stations for performing a polishing process described above.

### Examples of a Processing Station for a Polishing Process

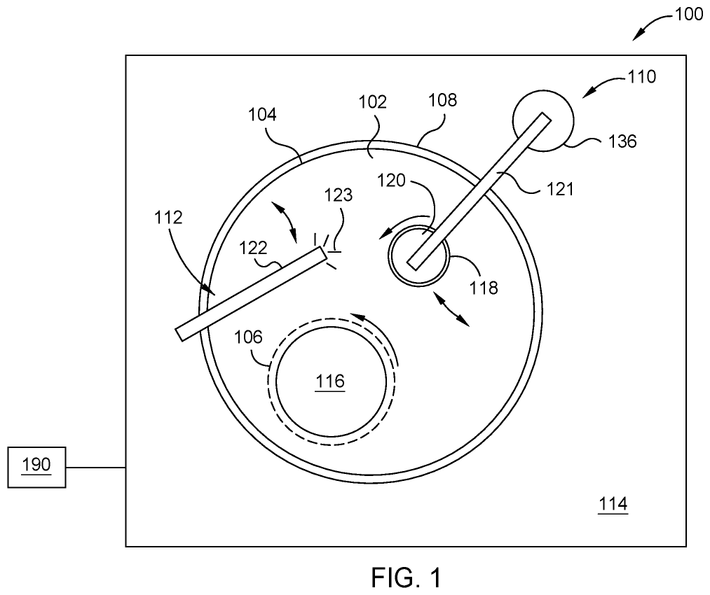

FIG. 1 depicts a top plan view of the processing station 100, according to some embodiments. The processing station 100 is configured to perform a polishing process, such as a chemical mechanical planarization (CMP) or electrochemical mechanical planarization (ECMP) process, while also being configured to clean a polishing surface 102 of a polishing pad 104. The processing station 100 may be a stand-alone unit or part of a larger processing system.

The processing station 100 includes a substrate carrier head 106 (shown in phantom), a platen 108, a conditioning module 110, and a polishing fluid delivery assembly, such as a slurry delivery assembly 112. The platen 108, the conditioning module 110 and the slurry delivery assembly 112 may be mounted to a base 114 of the processing station 100.

The platen 108 supports the polishing pad 104. The platen 108 is rotated by a motor (not show) so that the polishing pad 104 is rotated relative to a substrate 116 retained in the substrate carrier head 106 during processing. As such, terms such as upstream, downstream, in front, behind, incoming, outgoing, before, and after are generally to be interpreted relative to the motion or direction of the platen 108 and the polishing pad 104 supported thereon, as appropriate.

The substrate carrier head 106 is configured to retain the substrate 116 and controllably urge the substrate 116 against the polishing surface 102 of the polishing pad 104 during processing. The substrate carrier head 106 may also rotate the substrate 116 during processing.

The conditioning module 110 is configured to condition the polishing pad 104 by opening the pores of the polishing pad 104. The conditioning module 110 includes a support assembly 136, conditioning arm 121, conditioning head 120, and conditioning disk 118. The conditioning disk 118 may be a brush having bristles made of a polymer material or may have an abrasive surface comprising abrasive particles. In some embodiments, the conditioning disk 118 is a circular disk that contains abrasive particles such as diamonds. The conditioning head 120 is configured to retain the conditioning disk 118 and controllably urge the conditioning disk 118 against the polishing surface 102 of the polishing pad 104 during conditioning.

The conditioning disk 118 may be coupled with the conditioning head 120 by passive mechanisms such as magnets and pneumatic actuators that take advantage of the existing up and down motion of the conditioning arm 121. The conditioning disk 118 generally extends beyond the housing of the conditioning head 120 by about 0.2 mm to about 1 mm in order to contact the polishing surface 102. The conditioning disk 118 can be made of nylon, cotton cloth, polymer, or other soft material that will not damage the polishing surface 102. Alternatively, the conditioning disk 118 may be made of a textured polymer or stainless steel having a roughened surface with diamond particles adhered thereto or formed therein. The diamond particles may range in size between about 30 microns to about 100 microns. The conditioning head 120 may also rotate the conditioning disk 118 during conditioning.

The conditioning module 110 is adapted to move the conditioning head 120, and thus the conditioning disk 118, from an edge of the polishing pad 104 diameter (e.g., a circumference of the polishing pad 104) to at least a portion of the radius of the polishing pad 104 in a linear, arcing or sweeping motion. In particular, the support assembly 136 may position the conditioning head 120. The movement of the conditioning head 120 may be configured such that the entire surface of the polishing pad is conditioned. The slurry delivery assembly 112 is configured to deliver a polishing media, such as a fluid or slurry 123, to the polishing pad 104 while the substrate 116 is polished on the polishing surface 102. As one skilled in the art would understand, the polishing pad 104 may include any features that would retain the slurry 123, such as pores and/or polishing pad grooves found in the polishing pad 104. The slurry delivery assembly 112 includes a polishing fluid delivery arm, such as a slurry delivery arm 122 that may be located in front of or behind the substrate carrier head 106. The slurry delivery arm 122 delivers the slurry 123 to the polishing surface 102. The slurry delivery arm 122 and the carrier head 106 may similarly move in a linear, arcing or sweeping motion.

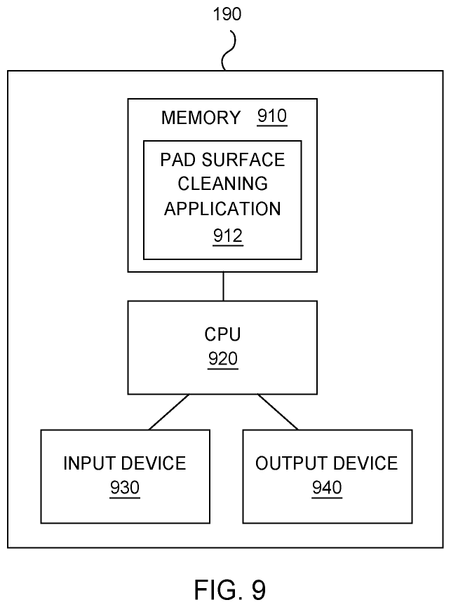

A system controller 190 may direct various operations of the processing station 100, such as controlling motion of the processing station 100. For example, the system controller 190 may move and control the position of the platen 108, the conditioning arm 121, and the slurry delivery arm 122 such that the polishing pad 104 is conditioned and the substrate 116 is polished. The system controller 190 is further discussed in relation to FIG. 9.

In some embodiments, the slurry delivery assembly 112 does not move during all or a portion of processing station 100 operations, such as during conditioning of the polishing pad 104.

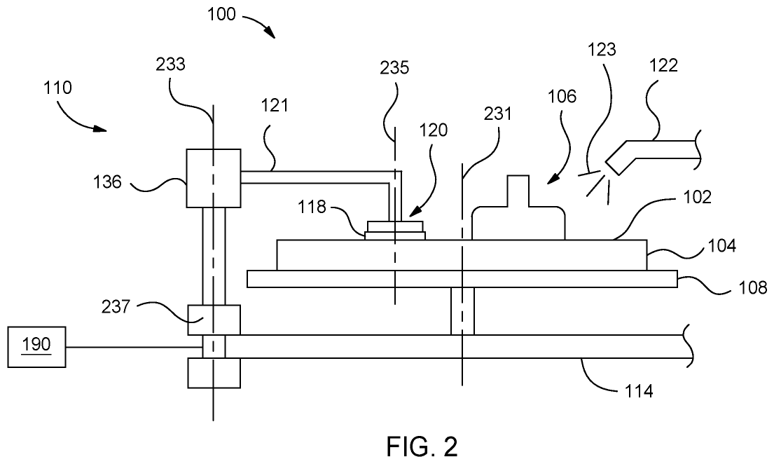

FIG. 2 depicts a schematic side view of the processing station 100, according to some embodiments. The polishing pad 104 is disposed on or supported on a surface of the platen 108, which rotates the polishing pad 104 and the polishing surface 102 during processing. The platen 108 may rotate about a first rotational axis 231. The slurry delivery arm 122 dispenses a fluid stream to the processing station 100. For example, the slurry delivery arm 122 may dispense the slurry 123 to the rotating polishing pad 104 at a continuous or variable feed rate.

The conditioning module 110 further includes a conditioning base 237 that mounts to the base 114. The conditioning arm 121 has a distal end coupled to the conditioning head 120 and a proximal end coupled to the conditioning base 237, such as through a support assembly 136. The conditioning base 237 may rotate the conditioning arm 121 about a second rotational axis 233 to position the conditioning head 120, for example, to sweep the conditioning head 120 across the polishing surface 102 to condition the polishing surface 102.

The conditioning head 120 may be used to restore polishing performance of the polishing surface 102, for example, by spinning the polishing pad 104 about a third rotational axis 235 of the conditioning head 120. The third rotational axis 235 may be in a center of or in a central location of the conditioning head 120. The conditioning head 120 may further provide a controllable pressure or downforce to controllably press the conditioning head 120 toward the polishing surface 102. In one embodiment, the down force can be in a range between about 0.5 lbf (22.2 N) to about 14 lbf (62.3 N), for example, between about 1 lbf (4.45 N) and about 10 lbf (44.5 N). The conditioning head 120 generally rotates and/or moves laterally in a sweeping motion across the polishing surface 102. In some embodiments, the conditioning head 120 may have a further range of motion to move the conditioning head 120 off the platen 108 when not in use.

### Examples of Pad Surface Cleaning Systems

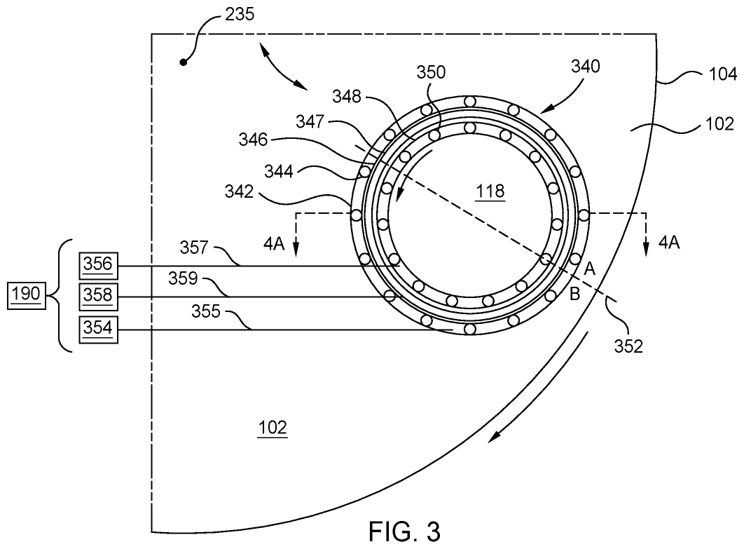

FIG. 3 depicts a top plan view of a pad surface cleaning system 340, according to some embodiments.

The pad surface cleaning system 340 may be used to clean the polishing surface 102 and/or to isolate the polishing disk 108 from the slurry 123 (FIGS. 1 and 2). The pad surface cleaning system 340 includes an outer wash ring 342 having outer nozzles 344, a vacuum ring 346 having a vacuum port 347, and an inner wash ring 348 having inner nozzles 350. In the embodiment depicted in FIG. 3, the pad surface cleaning system 340 fully surrounds the conditioning disk 118 and does not rotate with the conditioning disk 118. For example, the conditioning disk 118 may rotate about the third rotational axis 235 while the pad surface cleaning system 340 does not. Stated differently, the pad surface cleaning system 340 may remain stationary or fixed in relation to the third rotational axis 235. The pad surface cleaning system 340 may couple to the conditioning arm 121 such that the conditioning module 110 (FIGS. 1 and 2) moves the pad surface cleaning system 340 with the conditioning disk 118. The pad surface cleaning system 340 may be positioned downstream from the slurry delivery arm 122 (FIG. 1) and the substrate carrier head 106 may be positioned downstream from the pad surface cleaning system 340.

The outer and inner wash rings 342 and 348 spray a fluid on the polishing surface 102 to remove debris. The debris may comprise pieces of the substrate 116 (FIG. 1) removed during the polishing process or pieces of the polishing pad 104 or polishing disk 118 removed or dislodged during the conditioning process. The outer wash ring 342 may also be used to insulate the polishing disk 108 from the slurry 123 by to diluting, reducing, or eliminating an amount of slurry 123 that contacts the polishing disk 118. The vacuum ring 346 may remove or suck up the debris and the slurry 123 (or diluted slurry 123) before they contact the polishing disk 118. Diluting or removing the slurry 123 may reduce an acidity of the slurry 123 and prevent the slurry 123 from chemically reacting, corroding, or attacking the polishing disk 118, which may comprise stainless steel. Protecting the polishing disk 118 may extend the life of the polishing disk 118, which may reduce operational cost, for example, by reducing an amount of polishing disks 118 consumed and, as a result, reducing polishing station 100 (FIG. 1) down time needed to change out polishing disks 118. Diluting the slurry 123 may reduce a density of the slurry 123 and allow the vacuum ring 346 to remove the diluted slurry 123 easier than the slurry 123.

The outer nozzles 344 of the outer wash ring 342 deliver a high-pressure fluid spray to the polishing surface 102 to remove the debris, such as by-products from the polishing process, and to dilute or remove the slurry 123. Removing the debris prevents the polishing disk 118 from moving or smearing the debris across the polishing surface 102, which helps prevent the debris from becoming lodged or embedded in the polishing surface 102. Debris that is embedded in the polishing surface 102 may scratch the substrate 116 or become embedded in the substrate 116 during the polishing process, which may result in extra processing of or rejection of the polished substrate 116. The outer nozzles 344 are coupled to a first fluid source 354, such as a water or deionized water source, by a first fluid delivery line 355 and spray fluid from the first fluid source 354. In the depicted embodiment, the outer nozzles 344 are positioned around a diameter of the outer wash ring 342. In some embodiments, the outer nozzles 344 may be positioned at different diameters or angular positions of the outer wash ring 342.

The inner nozzles 350 of the inner wash ring 348 deliver a high-pressure fluid spray to the polishing surface 102 to remove the debris, such as by-products from the conditioning process, in a similar manner to the outer nozzles 344. The inner nozzles 350 are coupled to a second fluid source 356, such as a water or deionized water source, by a second fluid delivery line 357 and spray fluid from the second fluid source 356. In the depicted embodiment, the inner nozzles 350 are positioned around a diameter of the inner wash ring 348. In some embodiments, the inner nozzles 350 may be positioned at different diameters or angular positions of the inner wash ring 348. In some embodiments the high-pressure flow rate of the water or deionized water source through outer nozzles 344 and inner nozzles 350 may be at a flow rate of greater than 1 liter per minute.

The vacuum port 347 of the vacuum ring 346 is coupled to a vacuum source 358 through a vacuum line 359. The vacuum source 358 may be any system that can create a vacuum or suck fluid from the vacuum port 347 through the vacuum line 359, such as a Venturi system or vacuum pump. Thus, the vacuum ring 346 may remove the debris and slurry through the vacuum port 347 using a Venturi effect or an underpressure. In the depicted embodiment, the vacuum port 347 is a cylindrical-shaped opening (e.g., a hollow cylinder or tube) formed by the vacuum ring 346 and along a radius of the vacuum ring 346. For example, a radius of the vacuum port 347 may follow a radius of the vacuum ring 346, or a centerpoint of the vacuum port 347 may be roughly co-located with a centerpoint of the vacuum ring 346.

The pad surface cleaning system 340 may operate based on two zones: A and B. The zones A and B are separated by a zone boundary line 352. In the depicted embodiment, the zone boundary line 352 is a straight line that extends between a center of the polishing pad 104 (e.g., the third rotational axis 235) to the edge of the polishing pad 104 diameter, and thus is orthogonal (e.g., perpendicular) to the edge of the polishing pad 104 diameter, such as 90 degrees+/−5 degrees, such as 90 degrees+/−2 degrees, such as 90 degrees+/−1 degree, such as 90 degrees+/−0.5 degree, such as 90 degrees+/−0.25 degree. In some embodiments, the zone boundary line 352 may be orthogonal to a direction of a linear velocity of the polishing pad 104. The zone boundary line 352 may move with the pad surface cleaning system 340, such as in embodiments where the polishing disk 118 moves in a linear, arcing or sweeping motion. In such embodiments, the zone boundary line 352 may remain orthogonal to the edge of the polishing pad 104 diameter.

The zones A and B are arranged such that zone A includes portions of the outer wash ring 342, vacuum ring 346, and the inner wash ring 348 that are positioned over an incoming portion of the polishing pad 104, such as a portion of the polishing pad 104 moving towards the zone boundary line 352. Zone B includes portions of the outer wash ring 342, vacuum ring 346, and the inner wash ring 348 that are positioned over an outgoing portion of the polishing pad 104, such as a portion of the polishing pad 104 moving away from the zone boundary line 352.

A portion of the vacuum port 347 located in zone A is positioned downstream from the outer nozzles 344 located in zone A. A portion of the vacuum port 347 located in zone B is positioned downstream from the inner nozzles 350 located in zone B. Positioning the portion of the vacuum port 347 in zone A downstream from the outer nozzles 344 allows the vacuum ring 346 to recover fluid from the first fluid source 354, debris from polishing the substrate 116 (FIG. 1) using the carrier head 106 (FIG. 1), and the slurry 123 (FIG. 2) or used slurry 123. Positioning the portion of the vacuum port 347 in zone B downstream from the inner nozzles 350 allows the vacuum ring 346 to recover fluid from the second fluid source 356 as well as debris from conditioning the polishing surface 102 using the conditioning disk 118.

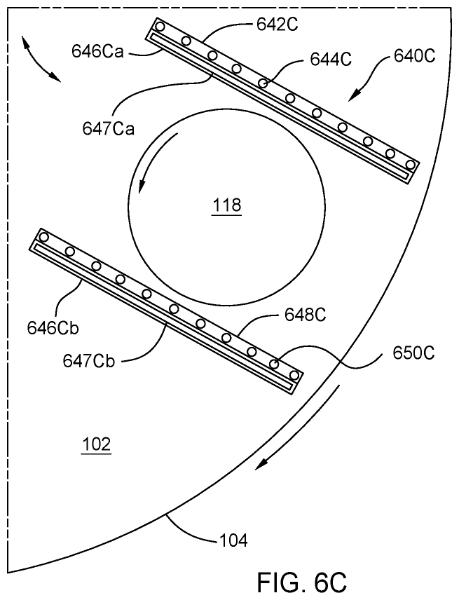

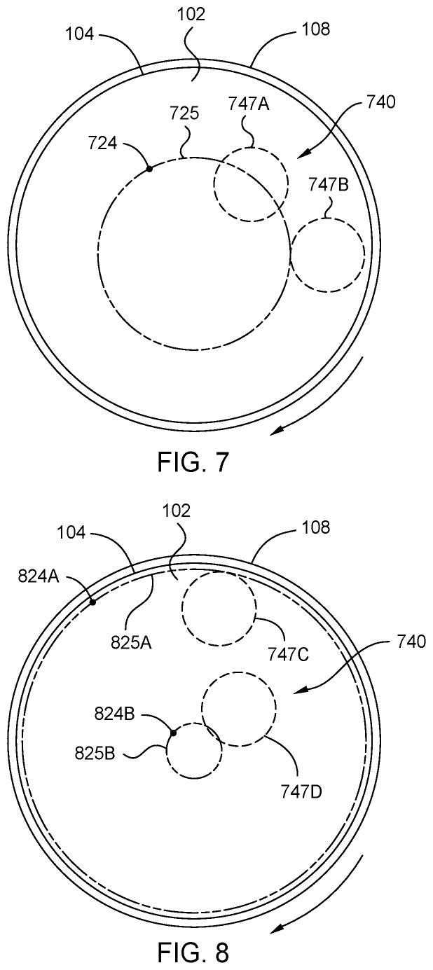

The system controller 190 may control the pad surface cleaning system 340 based on a position of the pad surface cleaning system 340. For example, the system controller 190 may control supply of fluids from the first and second fluid sources 354 and 356 (referred to collectively as rinse fluid) and the vacuum source 358 based on the position of the pad surface cleaning system 340 in relation to the slurry delivery arm 122. In some embodiments, the system controller 190 may stop supplying the rinse fluid when a part of the pad surface cleaning system 340 is within a radius of the polishing pad 104 occupied by a slurry 123 delivery point of the slurry delivery arm 122. This prevents dilution or removal of freshly applied slurry 123. Control of the rinse fluid is discussed further in relation to FIGS. 7 and 8.

The configuration of the pad surface cleaning system 340 (e.g., attached to the conditioning arm 121 and interfaced with the system controller 190) allows the pad surface cleaning system 340 to operate in situ or simultaneously with the processing station 100 (FIG. 1). For example, the pad surface cleaning system 340 may be used with the conditioning head 120 and conditioning disk 118 to condition the polishing surface 102 while the carrier head 106 polishes the substrate. Simultaneously conditioning and polishing may beneficially reduce operational costs and reduce substrate 116 processing time.

Although FIGS. 1-3 show the polishing pad 104 rotating clockwise and the conditioning disk 118 rotating counter-clockwise, the pads 104 and 118 may rotate differently. In some embodiments, the polishing pad 104 may rotate counter-clockwise and the conditioning disk 118 may rotate clockwise. In some embodiments, the pads 104 and 118 may rotate in the same direction, such as both clockwise or both counter-clockwise.

In some embodiments, the pad surface cleaning system 340 is disposed on a separate arm than the conditioning arm 121. In some embodiments, the pad surface cleaning system 340 is downstream of the slurry delivery arm 122 and the conditioning head 120.

In some embodiments, at least one nozzle of the outer and inner nozzles 344 and 350 may occupy both zones A and B. Such nozzles may operate as part of zone A or zone B, or may operate as part of both zones A and B.

In some embodiments, the first and second fluid sources 354 and 356 comprise different fluids. In some embodiments, the first and second fluid sources 354 and 356 comprise the same fluid. In some embodiments, the outer wash ring 342 may include outer nozzles 344 only in zone A and the inner wash ring 348 may include inner nozzles 350 only in zone B.

In some embodiments, the pad surface cleaning system 340 does not use zones A and B. In such embodiments, the fluid of the first fluid source 354 may be supplied to all outer nozzles 344 and the fluid of the second fluid source 356 may be supplied to all inner nozzles 350.

In some embodiments, the vacuum port 347 may comprise a converging or diverging section. In some embodiments, the vacuum port 347 may comprise a plurality of vacuum ports disposed in or formed by the vacuum ring 346. For example, the plurality of vacuum ports may be positioned around a diameter of the vacuum ring 346.

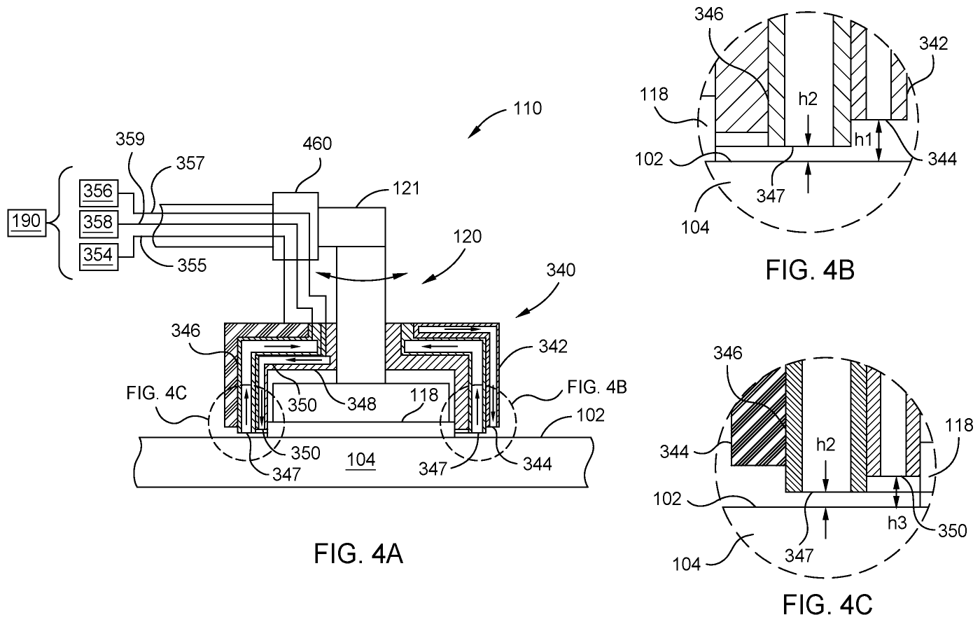

FIG. 4A depicts a schematic side view of the pad surface cleaning system 340 from FIG. 3, according to some embodiments. In particular, FIG. 4A shows a cross-sectional view of the pad surface cleaning system 340, where a nozzle 344 of the outer nozzles 344, a nozzle 350 of the inner nozzles 350, and the vacuum port 347 are cross-sectioned. The first and second fluid delivery lines 355 and 357 and the vacuum line 359 are coupled to the conditioning arm 121 through a mounting bracket 460, such as a clip, zip tie, bracket, or strap. In the depicted embodiment, the outer and inner nozzles 344 and 350 are cylinders connected to the first and second fluid delivery lines 355 and 357 through channels in the outer and inner wash rings 342 and 348. The channels may be referred to as outer and inner wash ring channels. The vacuum port 347 forms a cylindrical cutout in the vacuum ring 346 and includes a passageway in the vacuum ring 346 connected to the vacuum line 359. The passageway may be referred to as a vacuum ring channel.

In the embodiment depicted, the outer wash ring 342, vacuum ring 346, and inner wash ring 348 are shown as separate components and may be coupled or joined together, such as by press-fitting the inner wash ring 348 into the vacuum ring 346 and the vacuum ring 346 into the outer wash ring 342. Of course, it is contemplated that the outer wash ring 342, vacuum ring 346, and inner wash ring 348 may be joined together using a variety of other fastening means, including, but not limited to, various adhesives, various mechanical fasteners, or welding. In some embodiments, the outer wash ring 342, vacuum ring 346, and inner wash ring 348 may be integrally formed. For example, the outer wash ring 342, vacuum ring 346, and inner wash ring 348 may be machined out of a single billet of material, molded or printed as a single piece, welded or bonded together, or otherwise joined to together to function as a single article.

FIGS. 4B and 4C depict a schematic side view of the pad surface cleaning system 340 from FIG. 4A, according to some embodiments. In particular, FIG. 4B shows standoff distances from the outer nozzles 344 and vacuum port 347 to the polishing surface 102. FIG. 4C shows standoff distances from the inner nozzles 350 and vacuum port 347 to the polishing surface 102.

The outer nozzles 344 are positioned at a first standoff distance (h1) from the polishing surface 102. The vacuum port 347 is positioned at a second standoff distance (h2) from the polishing surface 102. The inner nozzles 350 are positioned at a third standoff distance (h3) from the polishing surface 102. As shown, the first standoff distance (h1) is greater than the third standoff distance (h3), which is greater than the second standoff distance (h2). Having the second standoff distance (h2) as the shortest distance positions the vacuum port 347 closer to the polishing surface 102 than the outer and inner nozzles 344 and 350, which may allow the vacuum port 347 to recover debris and slurry 123 (FIG. 2) without interference of the flow path through the vacuum port 347 from the outer and inner wash rings 342 and 348. The second standoff distance (h2) may also require less of a vacuum pressure from the vacuum source 358 than if the second standoff distance (h2) were larger. The first standoff distance (h1) and the third standoff distance (h3) may be based on the outer and inner nozzles 344 and 350. For example, the first and third standoff distances (h1) and (h3) may depend on an inlet diameter, exit diameter, or throat diameter of the nozzles 344 and 350, or a desired impact velocity of the rinse fluid, where the velocity of the rinse fluid may depend on the distance the rinse fluid travels from the outer and inner nozzles 344 and 350. The first and third standoff distances (h1) and (h3) may also depend on a desired cross-section of the rinse fluid at impact (e.g., a diameter of a cone spray pattern or a width of a flat fan spray pattern), where the cross-section may increase or decrease as the distance from the outer and inner nozzles 344 and 350 increases. In some embodiments, standoff distance (h1) may be between 10-100 mm. In some embodiments, standoff distance (h2) may be less than or equal to 10 mm. In some embodiments, standoff distance (h3) may be between 10-100 mm. In some embodiments, any or all of the standoff distances (h1), (h2), and (h3) may equal another.

Although shown as cylinders in FIGS. 3-4C, the outer and inner nozzles 344 and 350 may be a converging nozzle or a converging-diverging nozzle. In some embodiments the outer and inner nozzles 344 and 350 may be veejet nozzles, N2/DI mist atomizer nozzles, or combinations thereof.

Although FIGS. 1-4C show a circular platen 108 and circular polishing pad 104 in a rotary polisher, the polishing pad surface cleaning system 340 may be used with other polishing methods and designs. In some embodiments, the polishing pad 104 may be a conveyer belt that moves on rollers and the platen 108 may not rotate and remain stationary, such as in a linear polisher. In some embodiments, the platen 108 may move in an orbit around the first rotational axis 231 (FIG. 2) while rotating, such as in an orbital polisher.

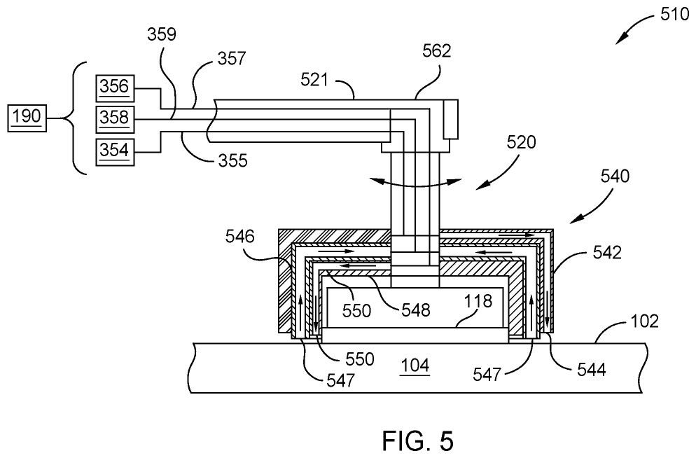

FIG. 5 depicts a schematic side view of a rotatable pad surface cleaning system 540, according to some embodiments.

A conditioning module 510 is similar to the conditioning module 110 discussed in relation to FIGS. 1-4A, except as noted. The conditioning module 510 includes a conditioning arm 521 coupled to a conditioning head 520 through a rotary union 562 or manifold. The conditioning head 520 spins or rotates the conditioning disk 118. The rotatable pad surface cleaning system 540 is similar to the pad surface cleaning system 340, except as noted. The rotatable pad surface cleaning system 540 fully surrounds the conditioning disk 118 and rotates with the polishing disk 118. The rotatable pad surface cleaning system 540 includes an outer wash ring 542 having outer nozzles 544, a vacuum ring 546 having a vacuum port 547, and an inner wash ring 548 having inner nozzles 550. The outer nozzles 544 are coupled to the first fluid source 354 through the first fluid delivery line 355, the inner nozzles 550 are coupled to the second fluid source 356 through the second fluid delivery line 357, and the vacuum port 547 is coupled to the vacuum source 358 through the vacuum line 359.

The first fluid delivery line 355, second fluid delivery line 357, and vacuum line 359 travel through the rotary union 562 to fluidly couple stationary first fluid source 354, second fluid source 356, and vacuum source 358 to rotating outer wash ring 342, inner wash ring 348, and vacuum ring 346, respectively. The rotary union 562 rotates in relation to the conditioning arm 521. The rotatable pad surface cleaning system 540 includes the zones A and B and zone boundary line 352 discussed in relation to FIG. 3. The zones A and B do not rotate with the rotatable pad surface cleaning system 540 and instead the zone boundary line 352 remains orthogonal to the edge of the polishing pad 104 diameter. The system controller 190 may control what nozzle or nozzles 544 and 550 of the outer and inner wash rings 542 and 548 are used based on the zone that each respective nozzle 544 and 550 is located in.

### Additional Examples of Pad Surface Cleaning Systems

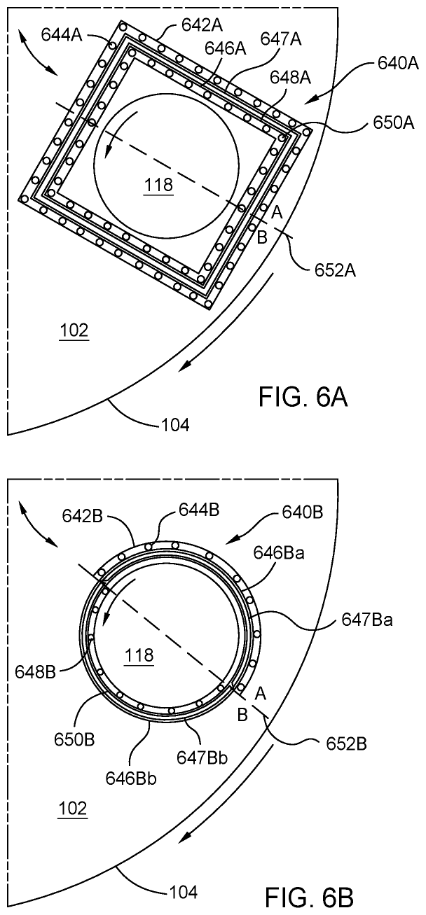

FIGS. 6A-6C depict top plan views of different pad surface cleaning systems 640 (e.g., 640A, 640B, and 640C), according to some embodiments. In particular, FIG. 6A shows a rectangular pad surface cleaning system 640A, which is similar to the pad surface cleaning system 340, except as noted.

The rectangular pad surface cleaning system 640A includes an outer wash ring 642A having outer nozzles 644A, a vacuum ring 646A having a vacuum port 647A, and an inner wash ring 648A having inner nozzles 650A. The outer wash ring 642A, vacuum ring 646A, and inner wash ring 648A each have a rectangular shape, where the inner wash ring 648A is nested inside the vacuum ring 646A, which is nested inside the outer wash ring 642A. The rectangular pad surface cleaning system 640A includes zones A and B and a zone boundary line 652A, which are used in a similar manner to the zones A and B and zone boundary line 352 discussed in relation to FIG. 3.

The rectangular pad surface cleaning system 640A may be used with the conditioning module 110 or 510, which may move the rectangular pad surface cleaning system 640A with the conditioning head 120 or 520 in a linear, arcing or sweeping motion. The rectangular pad surface cleaning system 640A may fully surround the conditioning disk 118.

In the depicted embodiment, two sides of the rectangular pad surface cleaning system 640A are roughly parallel to the zone boundary line 652A, such as within 5 degrees, such as within 3 degrees, such as within 1 degree, such as within 0.5 degrees. In some embodiments, the rectangular pad surface cleaning system 640A may not have sides positioned roughly parallel to the zone boundary line 652A. In some embodiments, the two sides of the rectangular pad surface cleaning system 640A may be parallel to each other but not the zone boundary line 652A. Although a rectangle is discussed in relation to FIG. 6A, other polynomial shapes may be used for the rectangular pad surface cleaning system 640A, such as square, pentagon, octagon, to name a few examples.

FIG. 6B shows a semi-circular pad surface cleaning system 640B, which is similar to the pad surface cleaning system 340, except as noted.

The semi-circular pad surface cleaning system 640B includes an arc-shaped (e.g., semi-circular) outer wash ring 642B having outer nozzles 644B and a corresponding first vacuum ring 646Ba having a vacuum port 647Ba. The semi-circular pad surface cleaning system 640B also includes an arc-shaped inner wash ring 648B having inner nozzles 650B and a corresponding second vacuum ring 646Bb having a vacuum port 647Bb. The first vacuum ring 646Ba has a semi-circular shape that is nested inside and downstream of the outer wash ring 642B. The second vacuum ring 646Bb has a semi-circular shape that is nested outside and downstream of the inner wash ring 642B. The first vacuum ring 646Ba extends past the outer wash ring 642B to capture a fluid sprayed through the outermost outer nozzles 644B. The second vacuum ring 646Bb extends past the inner wash ring 648B to capture a fluid sprayed through the outermost outer nozzles 644B.

The semi-circular pad surface cleaning system 640B may be used with the conditioning module 110 or 510, and may move with the conditioning head 120 or 520 in a linear, arcing or sweeping motion.

The semi-circular pad surface cleaning system 640B includes zones A and B and a zone boundary line 652B, which are used in a similar manner to the zones A and B and zone boundary line 352 discussed in relation to FIG. 3. In the depicted embodiment, the outer wash ring 642B and first vacuum ring 646Ba are positioned in zone A and the inner wash ring 648B and second vacuum ring 646Bb are positioned in zone B. In some embodiments, the outer and inner wash rings 642B and 648B may be positioned in both zones A and B, such as mostly in one of the zones and a portion in the other zone.

FIG. 6C shows a flat-bar pad surface cleaning system 640C, which is similar to the pad surface cleaning system 340, except as noted.

The flat-bar pad surface cleaning system 640C includes an outer wash ring 642C having outer nozzles 644C and a corresponding first vacuum ring 646Ca having a vacuum port 647Ca. The flat-bar pad surface cleaning system 640C further includes an inner wash ring 648C having inner nozzles 650C and a corresponding second vacuum ring 646Cb having a vacuum port 647Cb. The outer and inner wash rings 642C and 648C each have a rectangular shape and are roughly parallel to each other. The polishing disk 118 is positioned in between the outer and inner wash rings 642C and 648C.

The first vacuum ring 646Ca has a rectangular shape and is downstream of and adjacent to (e.g., coupled to) the outer wash ring 642C. The second vacuum ring 646Cb has a rectangular shape and is downstream of and adjacent to the inner wash ring 648C.

The flat-bar pad surface cleaning system 640C may be used with the conditioning module 110 or 510, and may move with the conditioning head 120 or 520 in a linear, arcing or sweeping motion.

In some embodiments, the outer and inner wash rings 642C and 648C may not be roughly parallel to each other. For example, each of the outer and inner wash rings 642C and 648C may be aligned to a radial line extending from a centerpoint of the polishing pad 104 to an edge of the polishing pad 104 diameter.

FIG. 7 depicts a top schematic view of a pad surface cleaning system 740 moving in relation to a polishing fluid delivery point 724, according to some embodiments. In particular, FIG. 7 shows how the pad surface cleaning system 740 may be controlled based on its position in relation to the polishing fluid delivery point 724.

The pad surface cleaning system 740 is similar to the pad surface cleaning system 340 (FIG. 3-4C), except as noted. The pad surface cleaning system 740 comprises an outer wash ring and inner wash ring (not shown) and a vacuum ring (not shown) having a vacuum port 747 (shown as a vacuum port 747A in a first position and vacuum port 747B in a second position). The polishing fluid delivery point 724 is a point where a polishing fluid, such as the slurry 123 discussed in relation to FIGS. 1-4C, contacts the polishing surface 102 of the polishing pad 104. The polishing fluid may disperse in a dispersal path 725 as the polishing pad 104 rotates. The vacuum port 747 may be coupled to a vacuum source (not shown) that provides an underpressure when the vacuum port 747 is not over the dispersal path 725 (as shown on the page). For example, the vacuum source may not provide the underpressure when the vacuum port 747A is within the dispersal path 725, such as when in the vacuum port 747A is in the first position. The vacuum source may provide the underpressure when the vacuum port 747 is outside of the dispersal path 725, such as when in the vacuum port 747B is in the second position. The system controller 190 (FIG. 3) may control the vacuum source using a pad surface cleaning system application 912 as described in relation to FIG. 9.

In the depicted embodiment, the dispersal path 725 is along a radius of the polishing pad 104. In some embodiments, the dispersal path 725 may not be a radius, such as embodiments having a linear or orbital polisher.

FIG. 8 depicts a top schematic view of the pad surface cleaning system 740 and a polishing fluid delivery point 824 moving in relation to the polishing pad 104, according to some embodiments. In particular, FIG. 8 shows how the pad surface cleaning system 740 may be controlled based on its position in relation to the polishing fluid delivery point 824.

The polishing fluid may be applied at several locations of the polishing pad 104 while the polishing pad 104 rotates, such as along a path from an edge of the polishing pad 104 diameter to at least a portion of the radius of the polishing pad 104. For example, the polishing fluid may be dispersed at a polishing fluid delivery point 824A at an outer location, a polishing fluid delivery point 824B at an inner location, or a polishing fluid delivery point at a location in between the outer and inner locations. The polishing fluid may disperse in a dispersal path 825 (e.g., an outer dispersal path 825A or an inner dispersal path 825B) as the polishing pad 104 rotates.

The vacuum source may provide an underpressure when the vacuum port 747 (shown as a vacuum port 747C in a third position and vacuum port 747D in a fourth position) is not over the dispersal path 825 (as shown on the page) (shown as an outer dispersal path 825A or an inner dispersal path 825B). For example, the vacuum source may not provide the underpressure when the vacuum port 747 is within the dispersal path 825, such as when in the vacuum port 747C is in the third position or when the vacuum port 747D is in the fourth position. The vacuum source may provide the underpressure when the vacuum port 747 is outside of the dispersal path 825, such as when in the vacuum port 747 is in between the third and fourth positions. Thus, the polishing fluid delivery point 824 may be coordinated with movement of the vacuum port 747 to ensure the vacuum source provides an underpressure when the vacuum port 747 is outside of the outer and inner locations of the polishing pad 104.

In some embodiments, the polishing fluid is dispersed from a slurry delivery arm 122 (FIG. 1) that moves along the path from an edge of the polishing pad 104 diameter to the at least a portion of the radius of the polishing pad 104.

Although FIGS. 7 and 8 are described in relation to the vacuum source and the vacuum port 747, in some embodiments the fluid from the first fluid source and/or the fluid from the second fluid source may not be provided when the outer nozzles and/or the inner nozzles are over the dispersal path 725 and 825.

### Example System Controller for a Pad Surface Cleaning System

FIG. 9 depicts a functional block diagram of the system controller 190 for a pad surface cleaning system (e.g., the pad surface cleaning systems 340, 540, 640, and 740 in FIGS. 3-8), according to some embodiments.

The system controller 190 includes a processor 920 (e.g., a central processing unit (CPU)) in data communication with a memory 910, an input device 930, and an output device 940. Although described separately, it is to be appreciated that functional blocks described with respect to the system controller 190 need not be separate structural elements. For example, the processor 920 and memory 910 is embodied in a single chip. The processor 920 can be a general purpose processor, a digital signal processor (“DSP”), an application specific integrated circuit (“ASIC”), a field programmable gate array (“FPGA”) or other programmable logic device, discrete gate or transistor logic, discrete hardware components, or any suitable combination thereof designed to perform the functions described herein. A processor may also be implemented as a combination of computing devices, e.g., a combination of a DSP and a microprocessor, a plurality of microprocessors, one or more microprocessors in conjunction with a DSP core, or any other such configuration.

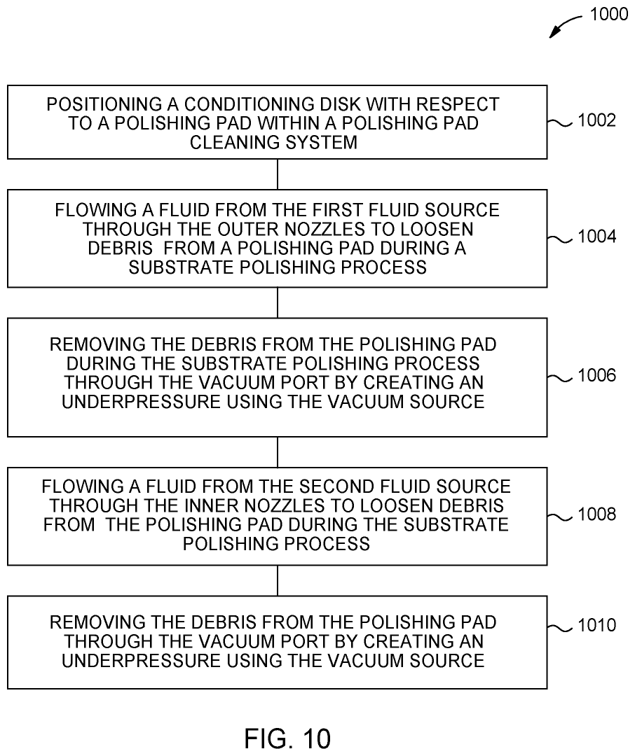

The processor 920 can be coupled, via one or more buses, to read information from or write information to memory 910. The processor may additionally, or in the alternative, contain memory, such as processor registers. The memory 910 can include processor cache, including a multi-level hierarchical cache in which different levels have different capacities and access speeds. The memory 910 can also include random access memory (RAM), other volatile storage devices, or non-volatile storage devices. The storage can include hard drives, flash memory, etc. Memory 910 can also include a pad surface cleaning system application 912 that is used to control the vacuum source, first fluid source, and second fluid source as described in FIGS. 7 and 8. Pad surface cleaning system application 912 may be code that can be executed by processor 920. In various instances, the memory is referred to as a computer-readable storage medium. The computer-readable storage medium is a non-transitory device capable of storing information, and is distinguishable from computer-readable transmission media such as electronic transitory signals capable of carrying information from one location to another. The non-transitory computer readable medium includes computer-executable instructions that, when executed by a processing system, cause the processing system to perform a method, as described in relation to FIG. 10, including: flowing a fluid from the first fluid source through the outer nozzles to loosen debris from a substrate polishing process, removing the debris from the substrate polishing process through the vacuum port by creating an underpressure using the vacuum source, flowing a fluid from the second fluid source through the inner nozzles to loosen debris from conditioning the polishing pad, and removing the debris from conditioning the polishing pad through the vacuum port by creating an underpressure using the vacuum source. Computer-readable medium as described herein may generally refer to a computer-readable storage medium.

The processor 920 also may be coupled to an input device 930 and an output device 940 for, respectively, receiving input from and providing output to a user of the system controller 190. Suitable input devices include, but are not limited to, a keyboard, buttons, keys, switches, a pointing device, a mouse, a joystick, a remote control, an infrared detector, a bar code reader, a scanner, a video camera (possibly coupled with video processing software to, e.g., detect hand gestures or facial gestures), a motion detector, or a microphone (possibly coupled to audio processing software to, e.g., detect voice commands). The input device 930 may include a positional sensor, such as an encoder, to sense a position of the pad surface cleaning system 340, 540, 640, and 740 (FIGS. 3-8) and/or the slurry delivery arm 122 (FIGS. 1 and 2). Suitable output devices include, but are not limited to, the conditioning base 237 (FIG. 2), a motor attached to the slurry delivery arm 122, as well as visual output devices, including displays and printers, audio output devices, including speakers, headphones, earphones, and alarms, additive manufacturing machines, and haptic output devices.

### Example Method for Conditioning a Polishing Pad

FIG. 10 depicts a flowchart of a method 1000 for a method for conditioning a polishing pad, according to some embodiments.

The method 1000 may be performed using any suitable processing station, such as the processing station 100 discussed in relation to FIGS. 1 and 2. The processing station 100 includes the pad surface cleaning system 340, 540, 640, or 740 set forth in FIGS. 3-6C.

At operation 1002, the method 1000 includes positioning a conditioning disk with respect to a polishing pad within a polishing pad cleaning system, as described above with respect to FIGS. 3-4C. In some embodiments, the polishing pad cleaning system includes an outer wash ring comprising outer nozzles, an inner wash ring comprising inner nozzles, and a vacuum ring. The outer nozzles are coupled to a first fluid source, the inner nozzles are coupled to a second fluid source, and the vacuum ring forms a vacuum port fluidly coupled to a vacuum source.

At operation 1004, the method 1000 includes flowing a fluid from the first fluid source through the outer nozzles to loosen debris from the polishing pad during a substrate polishing process, as described above with respect to FIGS. 3-6C.

At operation 1006, the method 1000 includes removing the debris from the polishing pad during the substrate polishing process through the vacuum port by creating an underpressure using the vacuum source, as described above with respect to FIGS. 3-8.

At operation 1008, the method 1000 includes flowing a fluid from the second fluid source through the inner nozzles to loosen debris from the polishing pad during the substrate polishing process, as described above with respect to FIGS. 3-6C.

At operation 1010, the method 1000 includes removing the debris from the polishing pad during the substrate polishing process through the vacuum port by creating an underpressure using the vacuum source, as described above with respect to FIGS. 3-8.

In some embodiments, the debris from the substrate polishing process is generated by polishing a substrate using the polishing pad.

In some embodiments, flowing the fluid from the first fluid source, removing the debris from the substrate polishing process, flowing the fluid from the second fluid source, and removing the debris from conditioning the polishing pad are performed simultaneously while polishing a substrate using the polishing pad.

Some embodiments further include rotating the polishing pad. Some embodiments further include dispensing a polishing fluid onto the polishing pad. Some embodiments further include moving the polishing pad cleaning system and the conditioning disk across a surface of the polishing pad, wherein the underpressure is created using the vacuum source when the vacuum port is outside of a dispersal path of the polishing fluid. Some embodiments further include moving the polishing fluid delivery arm across the polishing pad such that the polishing fluid is applied at several locations of the polishing pad.

Although method 1000 operations are described in conjunction with FIGS. 1-8, persons skilled in the art will understand that any system configured to perform method 1000 operations, in any order, falls within the scope of embodiments described herein.

While the foregoing is directed to embodiments of the present disclosure, other and further embodiments of the disclosure may be devised without departing from the basic scope thereof, and the scope thereof is determined by the claims that follow.

What is claimed is:

1. A polishing pad cleaning system for a substrate polishing process, the polishing pad cleaning system comprising:
an outer wash ring comprising outer nozzles, wherein the outer nozzles are configured to be coupled to a first fluid source;
an inner wash ring comprising inner nozzles, wherein the inner nozzles are configured to be coupled to a second fluid source; and
a vacuum ring, wherein the vacuum ring forms a vacuum port configured to be fluidly coupled to a vacuum source,
wherein:
a conditioning disk is configured to be disposed within the polishing pad cleaning system and to condition a polishing pad,
the outer nozzles are configured to loosen debris from the substrate polishing process,
the inner nozzles are configured to loosen debris from conditioning the polishing pad, and
the vacuum ring is configured to remove the debris loosened by the outer wash ring and inner wash ring.

2. The polishing pad cleaning system of claim 1, wherein the inner wash ring is disposed within the vacuum ring and the vacuum ring is disposed within the outer wash ring.

3. The polishing pad cleaning system of claim 1, wherein the outer nozzles, inner nozzles, and vacuum port are each positioned about an arc, semi-circle, or circle.

4. The polishing pad cleaning system of claim 1, wherein the outer wash ring, vacuum ring, and inner wash ring are integrally formed.

5. The polishing pad cleaning system of claim 1, wherein the vacuum ring comprises a first vacuum ring and a second vacuum ring, the first vacuum ring positioned downstream and adjacent to the outer wash ring and the second vacuum ring positioned downstream and adjacent to the inner wash ring.

6. The polishing pad cleaning system of claim 1, wherein the vacuum port is positioned downstream of the outer nozzles and the inner nozzles.

7. The polishing pad cleaning system of claim 1, wherein:
the polishing pad cleaning system comprises a first zone, a second zone, and a boundary line separating the first zone and the second zone,
the boundary line is orthogonal to an edge of the polishing pad, and
the outer nozzles are configured to loosen debris in the first zone and the inner nozzles are configured to loosen debris in the second zone.

8. The polishing pad cleaning system of claim 1, wherein the second fluid source is the same as the first fluid source.

9. The polishing pad cleaning system of claim 1, wherein the polishing pad cleaning system is configured to surround the conditioning disk.

10. A conditioning system for conditioning a polishing pad, the conditioning system comprising:
a conditioning module comprising a conditioning arm and a conditioning head, wherein the conditioning head is configured to urge a conditioning disk against the polishing pad; and
a polishing pad cleaning system coupled to the conditioning arm, wherein the polishing pad cleaning system comprises:
an outer wash ring comprising outer nozzles configured to couple to a first fluid source;
a vacuum ring comprising a vacuum port configured to couple to a vacuum source; and
an inner wash ring comprising inner nozzles configured to couple to a second fluid source.

11. The conditioning system of claim 10, wherein the conditioning head is configured to rotate the conditioning disk about a rotational axis of the conditioning head and the polishing pad cleaning system remains stationary in relation to the rotational axis of the conditioning head.

12. The conditioning system of claim 10, wherein the conditioning head is configured to rotate the conditioning disk and the polishing pad cleaning system about a rotational axis of the conditioning head.

13. The polishing pad cleaning system of claim 10, wherein the outer nozzles, inner nozzles, and vacuum port are each positioned about an arc, semi-circle, or circle.

14. The polishing pad cleaning system of claim 10, wherein the vacuum ring comprises a first vacuum ring and a second vacuum ring, the first vacuum ring positioned downstream and adjacent to the outer wash ring and the second vacuum ring positioned downstream and adjacent to the inner wash ring.

15. The polishing pad cleaning system of claim 10, wherein the vacuum port is positioned downstream of the outer nozzles and the inner nozzles.

16. A method for conditioning a polishing pad, comprising:
positioning a conditioning disk with respect to a polishing pad within a polishing pad cleaning system, wherein the polishing pad cleaning system comprises:
an outer wash ring comprising outer nozzles, wherein the outer nozzles are coupled to a first fluid source;
an inner wash ring comprising inner nozzles, wherein the inner nozzles are coupled to a second fluid source; and
a vacuum ring, wherein the vacuum ring forms a vacuum port fluidly coupled to a vacuum source;
flowing a fluid from the first fluid source through the outer nozzles to loosen debris from the polishing pad during a substrate polishing process;
removing the debris from the polishing pad during the substrate polishing process through the vacuum port by creating an underpressure using the vacuum source;
flowing a fluid from the second fluid source through the inner nozzles to loosen debris from the polishing pad during the substrate polishing process; and
removing the debris from the polishing pad during the substrate polishing process through the vacuum port by creating an underpressure using the vacuum source.

17. The method of claim 16, wherein the debris from the substrate polishing process is generated by polishing a substrate using the polishing pad.

18. The method of claim 17, wherein flowing the fluid from the first fluid source, removing the debris from the polishing pad, flowing the fluid from the second fluid source, and removing the debris from polishing pad are performed simultaneously while polishing a substrate using the polishing pad.

19. The method of claim 16, further comprising:
rotating the polishing pad;
dispensing a polishing fluid onto the polishing pad; and
moving the polishing pad cleaning system and the conditioning disk across a surface of the polishing pad, wherein the underpressure is created using the vacuum source when the vacuum port is outside of a dispersal path of the polishing fluid.

20. The method of claim 19, further comprising moving the polishing fluid delivery arm across the polishing pad such that the polishing fluid is applied at several locations of the polishing pad.
